(19) United States
(12) Patent Application Publication
(10) Pub. No.: US 2026/0304580 A1
(43) Pub. Date: Oct. 1, 2026

(54) Lighting configuration using wall plate with RFID tag

(71) Applicant: SIGNIFY HOLDING B.V., EINDHOVEN (NL)

(72) Inventors: VOYA VIDAKOVIC, MARIETTA, GA (US); NAM CHIN CHO, PEACHTREE CITY, GA (US)

(21) Appl. No.: 18/996,567

(22) PCT Filed: Jul. 11, 2023
(86) PCT No.: PCT/EP2023/069121

§ 371 Date: Jan. 17, 2025

Related U.S. Application Data
(60) Provisional application No. 63/390,790, filed on Jul. 20, 2022.

(30) Foreign Application Priority Data
Jul. 29, 2022 (EP) 22187856.4

(51) Int. Cl. H05B 47/175; H05B 47/135; H05B 47/18; H05B 47/19

(52) U.S. Cl. CPC H05B 47/199; H05B 47/135; H05B 47/18; H05B 47/19

(57) ABSTRACT

A lighting system includes a wall station having a wall plate that is removably attachable to a control unit of the wall station, where a radio-frequency identification (RFID) tag is attached to the wall plate. The lighting system further includes a light fixture comprising an RFID unit configured to read a wall station identifier of the wall station from the RFID tag when the RFID tag is within a threshold distance from the light fixture. The control unit of the wall station is configured to transmit a lighting control message that includes the wall station identifier, and the light fixture is configured to operate based on the lighting control message in response to determining that the lighting control message includes the wall station identifier.

### TECHNICAL FIELD

The present disclosure relates generally to lighting solutions, and in particular to lighting configuration including commissioning of lighting systems using a wall plate that has an attached radio-frequency identification (RFID) tag.

### BACKGROUND

A typical lighting system may have multiple luminaires and a fixed, line powered wall station (e.g., a dimmer) that controls the luminaires wirelessly. Commissioning or otherwise configuring a typical lighting system often requires a commissioning software resident on either a mobile device or computer. During a lighting system commissioning process, linking a wall station to a specific set of luminaires for control by the wall station can be time consuming and complicated. For example, locating the identifiers (e.g., serial numbers) of the luminaires for configuring the wall station may be time consuming. Thus, a solution that simplifies the configuring of a lighting system may be desirable.

### SUMMARY

In general, the present disclosure relates to lighting solutions, and in particular to lighting configuration including commissioning of lighting systems using a wall plate that has an attached radio-frequency identification (RFID) tag. In an example embodiment, A lighting system includes a wall station having a wall plate that is removably attachable to a control unit of the wall station, where a radio-frequency identification (RFID) tag is attached to the wall plate. The lighting system further includes a light fixture comprising an RFID unit configured to read a wall station identifier from the RFID tag when the RFID tag is within a threshold distance from the light fixture. The control unit of the wall station is configured to transmit a lighting control message that includes the wall station identifier, and the light fixture is configured to operate based on the lighting control message in response to determining that the lighting control message includes the wall station identifier.

In another example embodiment, a method of configuring a lighting system includes removing a wall plate of a wall station from a control unit of the wall station, where an RFID tag is attached to the wall plate. The method further includes placing the wall plate along with the RFID tag within a threshold distance from a light fixture that includes an RFID unit configured to read a wall station identifier from the RFID tag. The method also includes reattaching the wall plate to the wall control unit, wherein the control unit is configured to transmit a lighting control message that includes the wall station identifier and wherein the light fixture is configured to operate based on the lighting control message in response to determining that the lighting control message includes the wall station identifier.

These and other aspects, objects, features, and embodiments will be apparent from the following description and the claims.

### BRIEF DESCRIPTION OF THE DRAWINGS

Reference will now be made to the accompanying figures, which are not necessarily to scale, and wherein:

FIG. 1 illustrates a wall station for controlling light fixtures according to an example embodiment;

FIGS. 2 and 3 illustrate the wall station of FIG. 1 with a wall plate detached from the control unit of the wall station according to an example embodiment;

FIGS. 4 and 5 illustrate the wall station of FIG. 1 with the wall plate detached from the control unit of the wall station according to another example embodiment;

FIG. 6 illustrates a block diagram of the control unit of the wall station of FIG. 1 according to an example embodiment;

FIG. 7 illustrates a block diagram of a light fixture that is controllable by the wall station of FIG. 1 according to an example embodiment;

FIG. 8 illustrates a lighting system that includes the wall station of FIG. 1 according to an example embodiment;

FIG. 9 illustrates the lighting system of FIG. 8 with the wall plate of the wall station placed within a threshold distance from a light fixture according to an example embodiment; and

FIG. 10 illustrates a method of configuring the lighting system of FIG. 8 according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the figures, reference numerals designate like or corresponding, but not necessarily identical, elements.

### DETAILED DESCRIPTION OF THE EXAMPLE EMBODIMENTS

In the following paragraphs, particular embodiments will be described in further detail by way of example with reference to the figures. In the description, well known components, methods, and/or processing techniques are omitted or briefly described.

Furthermore, reference to various feature(s) of the embodiments is not to suggest that all embodiments must include the referenced feature(s).

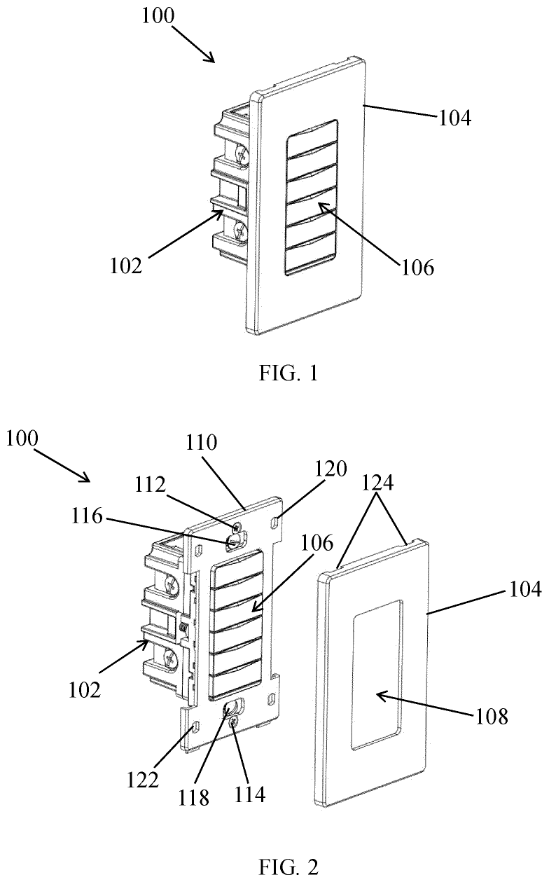

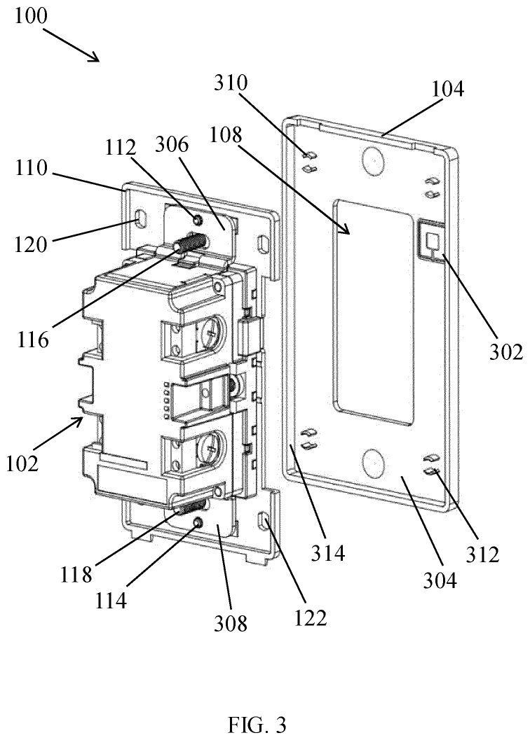

FIG. 1 illustrates a wall station 100 for controlling light fixtures according to an example embodiment, and FIGS. 2 and 3 illustrate the wall station of FIG. 1 with the wall plate detached from the control unit of the wall station according to an example embodiment. In some example embodiments, the wall station 100 includes a control unit 102 and a wall plate 104 that is removably attached to the control unit 102. The wall plate 104 may be made, for example, from plastic. The control unit 102 may include a user input interface 106 that can be used by a user to provide inputs to the control unit 102. To illustrate, the user input interface 106 may include buttons that a use can press to provide an input to the control unit 102. For example, a user may use the user input interface 106 to turn on and off light fixtures, dim lights provide by light fixtures, change scene settings, and/or change color temperature of lights provided by light fixtures.

In some example embodiments, a user may use the user input interface 106 to provide one or more inputs to the wall station 100 to initiate a commission mode of a lighting system that includes the wall station 100 and light fixtures. For example, in response to a user pressing one or more particular buttons of the user input interface 106, the wall station 100 may enter a commissioning mode and also send a command to light fixtures in the vicinity of the wall station 100 to enter the commissioning mode.

In some example embodiments, the control unit 102 may include a back plate 118 to which the wall plate 104 can be removably attached. The control unit 102 may be attached to an electrical box (not shown) using fasteners 116 and 118 that extend through holes in brackets 306 and 308, respectively. The back plate 110 may be attached to the bracket 306 by a fastener 112 and to the bracket 308 by a fastener 114.

In some example embodiments, the wall plate 104 may have an opening 108 that is aligned with the user input interface 106 of the control unit 102 such that the user interface 106 is accessible through the opening 108. The wall plate 104 may include snaps, such as snaps 310, 312, aligned with receiving holes, such as holes 120, 122, of the back plate 110. The snaps 310, 312 may extend out from a back surface 304 of the wall plate 104 facing the control unit 102. For example, the snaps 310 and 312 may be aligned with the holes 120 and 122, respectively, such that the snap 310 is inserted in the hole 120 and the snap 312 is inserted in the hole 122 to securely attach the wall plate 104 to the back plate 110 and thus to the control unit 102. A perimeter lip 314 of the wall plate 104 may be positioned around the perimeter of the back plate 110 when wall plate 104 is attached to the back plate 110. The wall plate 104 may be removed from the control unit 102, for example, by prying the wall plate 104 off using a finger or a small tool (e.g., a flat screwdriver) at notches 124 of the wall plate 104.

In some example embodiments, an RFID tag 302 is attached to the back surface 304 of the wall plate 104 facing the control unit 102. ‘RFID’ as used throughout this application including the claims is intended to include standard radio-frequency identification technology, near-field communication technology, and other similar technologies. The RFID tag 302 may be attached to the wall plate 104 using an adhesive an/or a mechanical means as can be readily understood by those of ordinary skill in the art with the benefit of this disclosure. The RFID tag 302 may include an EEPROM (Electrically Erasable Programmable Read Only Memory), such as a dual port EDPROM, that contains a wall station identifier of the wall station 100. For example, the wall station identifier may be a serial number of the wall station 100, a MAC address of the wall station 100, or another identifier as can be readily understood by those of ordinary skill in the art with the benefit of this disclosure. The wall station 100 may control light fixtures that are paired with the wall station 100 based on the wall station identifier as can be readily understood by those of ordinary skill in the art. For example, lighting control messages transmitted by the wall station 100 may include the wall station identifier, and light fixtures that are paired with the wall station 100 may operate based on the lighting control messages in response to recognizing the wall station identifier.

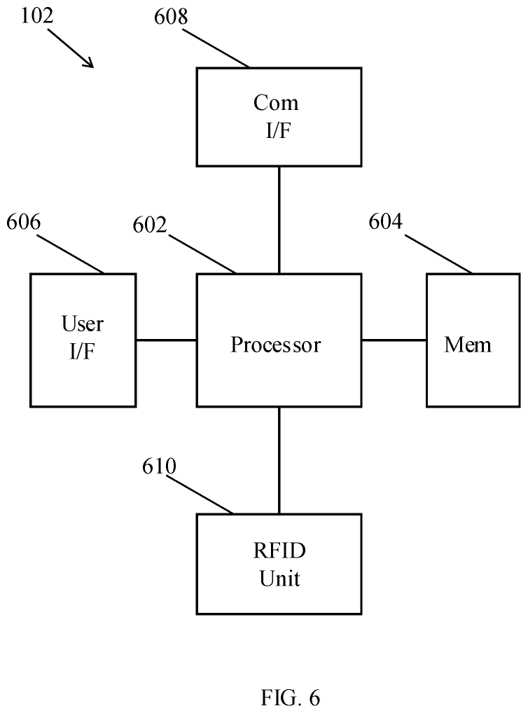

In some example embodiments, the wall station identifier may be stored in the RFID tag 302 at the factory during the manufacturing of the wall station 100. Alternatively or in addition, the wall station identifier may be stored in the RFID tag 302 after manufacturing. For example, the wall station identifier may be written to the RFID tag 302 by an RFID device (e.g., a handheld RFID writer device) as can be readily understood by those of ordinary skill in the art. As another example, in some alternative embodiments, the control unit 102 may include an RFID unit (for example, an RFID unit shown in FIG. 6) that can write to the RFID tag 302 wirelessly, and the control unit 102 may write the wall station identifier to the RFID tag 302, for example, upon initial power connection, upon the powering up of the wall station 100, or in response to a user input.

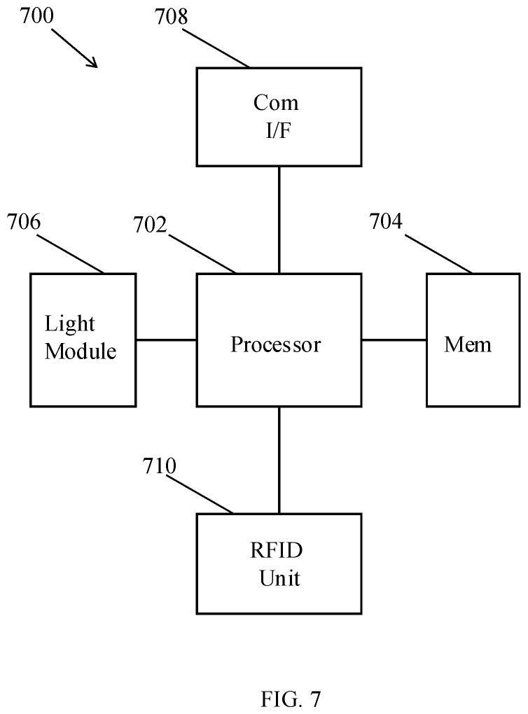

In some example embodiments, if a user (e.g., a technician or a homeowner) wants a particular light fixture to be controlled by the wall station 100 either during commissioning or during a subsequent configuration of a lighting system, the user may pair the particular light fixture with the wall station 100. To illustrate, a user may provide an input to the wall station 100 via the user input interface 106 to initiate a commissioning mode operation, and the wall station 100 may broadcast a commissioning mode command wirelessly in response to the user input. The user may then detach the wall plate 104 (i.e., the wall plate 104 along with the RFID tag 302) from the control unit 102 and move the wall plate 104 within a threshold distance of the light fixture. The light fixture, which enters the commission mode in response to the commissioning mode command, may include an RFID unit (for example, an RFID unit shown in FIG. 7) that can read the wall station identifier from the RFID tag 302 when the RFID tag 302 is within the threshold distance. For example, the user may hold the wall plate 104 within the threshold distance for at least a minimum time period (e.g., 1 second, 3 seconds, 5 seconds, or 30 seconds).

In some example embodiments, the threshold distance from the light fixture may range, for example, from a few centimeters to a few feet (e.g., 10 feet), for example, depending on the RFID unit of the light fixture as can be readily understood by those of ordinary skill in the art with the benefit of this disclosure. In general, the threshold distance is less than an installation distance between the wall station 100 and the light fixture, where the installation distance is the separation between the wall station 100 and the light fixture after installation. The light fixture may provide an indicator signal (e.g., a flashing light) to indicate that the RFID unit of the light fixture has read the wall station identifier from the RFID tag 302. For example, the light fixture may exit the commissioning mode after providing the indicator signal, after a time out period (e.g., 5 minutes or 10 minutes), or upon receiving a command from the wall station 100 to exit the commissioning mode.

In some example embodiments, after the light fixture provides the indicator signal or after holding the wall plate 104 within the threshold distance from the light fixture for the minimum time period (e.g., 30 seconds or 1 minute), the user may reattach the wall plate 104 to the control unit 102 and provide a user input to the wall station 100 via the user input interface 106 to terminate the commissioning mode. Alternatively, the wall station 100 may terminate the commissioning mode after a commissioning time period (e.g., 5 minutes, 10 minutes, or 30 minutes). The wall station 100 may broadcast a commissioning mode termination command upon the termination of the commissioning mode. If the light fixture has successfully read the wall station identifier from the RFID tag 302, the light fixture will respond to lighting control messages from the wall station 100 in response to recognizing the wall station identifier in the lighting control messages. For example, the light fixture may turn on, turn off, dim, etc. its light in response to lighting control messages from the wall station 100 transmitted wirelessly. In some example embodiments, a user may pair other light fixtures with the wall station 100 in the same manner before terminating the commissioning mode or by reentering the commissioning mode.

In some example embodiments, instead of or in addition reading the wall station identifier from the RFID tag 302, the light fixture may write the light fixture identifier of the light fixture to the RFID tag 302 while the wall plate 104 is within the threshold distance from the light fixture during the commissioning mode. For example, the RFID unit of the light fixture may write the light fixture identifier to the RFID tag 302. When the wall plate 104 is reattached to the control unit 102, the control unit 102 may read the light fixture identifier from the RFID tag 302. For example, the RFID unit of the control unit 102 may wirelessly read the light fixture identifier from the RFID tag. After exiting the commissioning mode, the wall station 100 may wirelessly transit lighting control messages to the particular light fixture using the light fixture identifier (e.g., including the wall station identifier in the lighting control messages) as can be readily understood by those of ordinary skill in the art with the benefit of this disclosure.

In some example embodiments, because the RFID tag 302 can have a memory unit that can store multiple light fixture identifiers, before reattaching the wall plate 104 to the control unit 102, the wall plate 104 may be sequentially moved within the threshold distance from multiple light fixtures that each write a respective light fixture identifier to the RFID tag 302. When the wall plate 104 is reattached to the control unit 102, the RFID unit of the control unit 102 may wirelessly read the light fixture identifiers of the multiple light fixtures from the RFID tag, enabling the wall station 100 to send lighting control messages to specific light fixtures. A particular light fixture may operate based on the received lighting control messages in response to recognizing the light fixture identifier of the particular light fixture in one or more of the lighting control messages.

By using the wall plate 104 with the attached RFID tag 302, a user can quickly and intuitively pair light fixtures with the wall station 100. By using the wall plate 104 with the attached RFID tag 302 to perform lighting system configuration including commissioning, complicated steps of pairing light fixtures with wall stations may be avoided. By using the wall plate 104 with the attached RFID tag 302 to obtain the light fixture identifier of a particular light fixture, the wall station 100 and the light fixture may be paired in a manner that enables the wall station 100 to wirelessly control the particular light fixture.

In some alternative embodiments, the wall station 100 including the wall plate 104 may have a different shape than shown in FIGS. 1-3 without departing from the scope of this disclosure. For example, the perimeter shape of the wall plate 104 and the opening 108 may have different shapes than shown without departing from the scope of this disclosure. In some alternative embodiments, the RFID tag 302 may be attached to the wall plate 104 at a different location than shown without departing from the scope of this disclosure. In some alternative embodiments, the wall plate 104 may be attached to the control unit 102 in a different manner than described without departing from the scope of this disclosure. For example, instead or in addition to the snaps 310, 312, one or more fasteners (e.g., screws and/or clips) may be used to attach the wall plate 104 to the control unit 102. In some alternative embodiments, one or more components of the wall station 100 may be omitted or replaced by another component without departing from the scope of this disclosure. For example, the RFID unit of the wall station 100 may be omitted without departing from the scope of this disclosure. As another example, the fasteners 116, 118 may be omitted, and the wall station 100 may be attached to an electrical box using other means as can be readily understood by those of ordinary skill in the art. In some alternative embodiments, the user input interface 106 may be a different type of user interface. For example, the user input interface 106 may include a touch screen instead of or in addition to buttons. In some alternative embodiments, a user may provide inputs to the wall station 100 to enter the commissioning mode after detaching the wall plate 104 from the control unit 102 without departing from the scope of this disclosure. In some alternative embodiments, a user may provide inputs to the wall station 100 to terminate the commissioning mode before reattaching the wall plate 104 to the control unit 102 without departing from the scope of this disclosure.

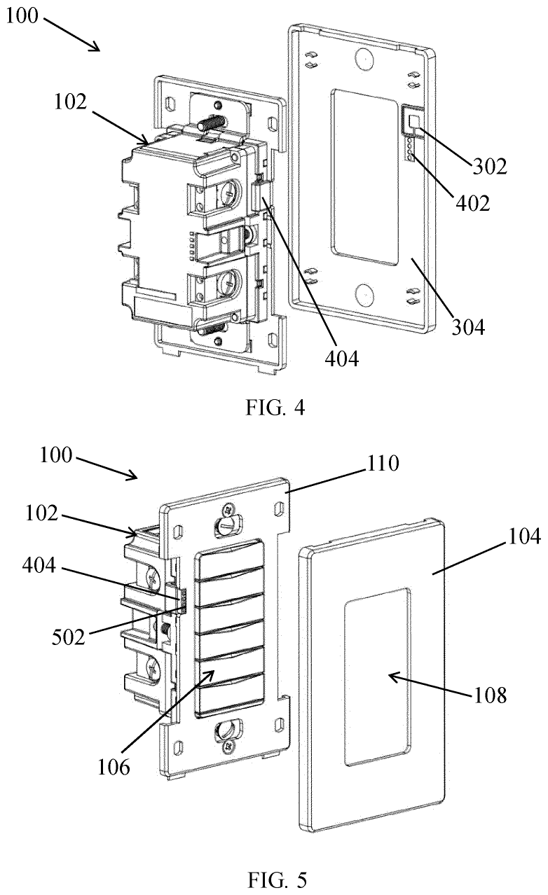

FIGS. 4 and 5 illustrate the wall station 100 of FIG. 1 with the wall plate 104 detached from the control unit 102 of the wall station 100 according to another example embodiment. Referring to FIGS. 1, 4, and 5, the wall station 100 includes the control unit 102 and the wall plate 104, where the user input interface 106 is accessible through the opening 108 of the wall plate 104 when the wall plate 104 is attached to the control unit 102 as described above with respect to FIGS. 1-3. As described above with respect to FIGS. 1-3, a user may use the user input interface 106 to provide inputs to the wall station 100, for example, to initiate a commissioning mode, to terminate the commissioning mode, and to control light fixtures paired with the wall station 100. The wall plate 104 along with the RFID tag 302 in the embodiment shown in FIGS. 4 and 5 may be used to pair the wall station 100 with a light fixture by placing the wall plate 104 within a threshold distance from the light fixture in the manner described with respect to FIGS. 1-3.

In some example embodiments, in contrast to the embodiment of the wall station 100 shown in FIGS. 2 and 3, the wall station 100 may include electrical contacts 402 that are located on the back surface 304 of the wall plate 104 as shown in FIGS. 4 and 5, where the electrical contacts 402 are electrically connected to the RFID tag 302. Indeed, in some example embodiments, the electrical contacts 402 may be ports of the RFID tag 302.

For example, the electrical contacts 402 may be used to serially read from and/or write to the memory device (e.g., an EEPROM) of the RFID tag 302 via a wired connection as can be readily understood by those of ordinary skill in the art with the benefit of this disclosure.

To illustrate, the control unit 102 may include a wire connector 404 that has electrical contacts 502 that are aligned to come in contact with the electrical contacts 402 when the wall plate 104 is attached to the back plate 110. For example, the electrical contacts 502 may be electrically connected to the RFID unit (for example, an RFID unit shown in FIG. 6) of the control unit 102, and the RFID unit of the control unit 102 may read from and/or write to the RFID tag 302 via the electrical contacts 502 instead of or in addition to reading and/or writing wirelessly.

In some example embodiments, the control unit 102 may write the wall station identifier of the wall station 100 to the RFID tag 302 via the electrical contacts 502 that are in contact with the electrical contacts 402 when the wall plate 104 is attached to the control unit 102. When the wall plate 104 with the RFID tag 302 is detached from the control unit 102 and placed within a threshold distance from a light fixture in the manner described with respect to FIGS. 1-3, the RFID unit (e.g., an RFID unit shown in FIG. 7) of the light fixture may wirelessly read the wall station identifier from the RFID tag 302. After the light fixture reads the wall station identifier from the RFID tag 302, the wall plate 104 may be reattached to the control unit 102. After exiting the commissioning mode as described above, the wall station 100 may control the light fixture using lighting control messages. The light fixture may operate based on the lighting control messages in response to recognizing the wall station identifier.

In some example embodiments, when the wall plate 104 along with the RFID tag 302 are placed within a threshold distance from a light fixture during the commissioning mode of the light fixture, the RFID unit (e.g., an RFID unit shown in FIG. 7) of the light fixture may wirelessly write the light fixture identifier to the RFID tag 302 instead of or in addition to wirelessly reading the wall station identifier from the RFID tag 302. In contrast to the embodiment of the wall station 100 described with respect to FIGS. 1-3, instead of reading light fixture identifiers of light fixtures from the RFID tag 302 wirelessly, the control unit 102 may read light fixture identifiers from the RFID tag 302 via the electrical contacts 502 after one or more light fixtures have written their respective light fixture identifiers to the RFID tag 302 as described above with respect to FIGS. 1-3. After exiting the commissioning mode, the wall station 100 may send lighting control messages to specific light fixtures based on the light fixture identifiers read from the RFID tag 302. A particular light fixture may operate based on received lighting control messages in response to recognizing the light fixture identifier of the particular light fixture in one or more of the lighting control messages from the wall station 100.

In some alternative embodiments, the wall station 100 including the wall plate 104 may have a different shape than shown in FIGS. 1, 4, and 5 without departing from the scope of this disclosure. In some alternative embodiments, the RFID tag 302 and the electrical contacts 402 may be attached to the wall plate 104 at different locations than shown without departing from the scope of this disclosure. In some alternative embodiments, one or more components of the wall station 100 may be omitted or replaced by another component without departing from the scope of this disclosure. In some alternative embodiments, the user input interface 106 may be a different type of user interface. In some alternative embodiments, a user may provide inputs to the wall station 100 to enter the commissioning mode after detaching the wall plate 104 from the control unit 102 without departing from the scope of this disclosure. In some alternative embodiments, a user may provide inputs to the wall station 100 to terminate the commissioning mode before reattaching the wall plate 104 to the control unit 102 without departing from the scope of this disclosure.

FIG. 6 illustrates a block diagram of the control unit 102 of the wall station 100 of FIG. 1 according to an example embodiment. Referring to FIGS. 1-6, in some example embodiments, the control unit 102 may include a processor 602 (e.g., one or more microprocessor or microcontrollers), a memory device 604 (e.g., one or more static random access memory devices, flash memory devices, and other types of memory devices), and a user interface module 606, and a communication interface module 608. The control unit 102 may also include an RFID unit 610. For example, the user interface module 606 may include the user input interface 106 described above. The user interface module 606 may also include a user display interface as can be readily understood by those of ordinary skill in the art with the benefit of this disclosure. The communication interface module 608 may include one or more transmitters, receivers, and transceivers that are designed to transmit and receive wireless signals compliant with one or more of Wi-Fi, BLE, ZigBee, UWB, cellular network, etc. communication standards or protocols. For example, the processor 602 may communicate with one or more light fixtures and/or network devices via the communication interface module 608.

In some example embodiments, the memory device 604 may be used to store executable software as well as data. The processor 602 may execute the software stored in the memory device 604 to control and perform operations described herein with respect to the wall station 100. For example, the processor 602 may process user inputs received from a user via the user interface module 606. To illustrate, the processor 602 may enter and exit commissioning mode and transmit lighting control messages to light fixtures in response to user inputs provided via the user interface module 606. The processor 602 may also display information via the user interface module 606. The processor 602 may control the RFID unit 610 to write to and/or read from the RFID tag 302. For example, the RFID unit 610 may read from and/or write to the RFID tag 302 wirelessly and/or via the electrical contacts 502 shown in FIG. 5.

In some alternative embodiments, the control unit 102 may include more or fewer components than shown in FIG. 6 without departing from the scope of this disclosure. For example, the RFID unit 610 may be omitted without departing from the scope of this disclosure. In some alternative embodiments, some of the components of the control unit 102 shown in FIG. 6 may be integrated into a single component without departing from the scope of this disclosure.

FIG. 7 illustrates a block diagram of a light fixture 700 that is controllable by the wall station 100 of FIG. 1 according to an example embodiment. Referring to FIGS. 1-7, in some example embodiments, the light fixture 700 may include a processor 702 (e.g., one or more microprocessor or microcontrollers), a memory device 704 (e.g., one or more static random access memory devices, flash memory devices, and other types of memory devices), and a light module 706, and a communication interface module 708. The light fixture 700 may also include an RFID unit 710. For example, the light module 706 may include one or more light sources (e.g., LED light sources) that emit a light. The communication interface module 708 may include one or more transmitters, receivers, and transceivers that are designed to transmit and receive wireless signals compliant with one or more of Wi-Fi, BLE, ZigBee, UWB, cellular network, etc. communication standards or protocols. For example, the processor 702 may communicate with the wall station 100 via the communication interface module 708.

In some example embodiments, the memory device 704 may be used to store executable software as well as data. The processor 702 may execute the software stored in the memory device 704 to control and perform operations described herein with respect to the light fixtures. For example, the processor 702 may enter and exit commissioning mode, process lighting control messages received from the wall station 100, control the light module 706 based on received lighting control messages, etc. The processor 702 may also control the RFID unit 710 to wirelessly read from and/or write to the RFID tag 302 of the wall plate 104 of the wall station 100.

In some alternative embodiments, the light fixture 700 may include more or fewer components than shown in FIG. 7 without departing from the scope of this disclosure. In some alternative embodiments, some of the components of the light fixture 700 shown in FIG. 7 may be integrated into a single component without departing from the scope of this disclosure.

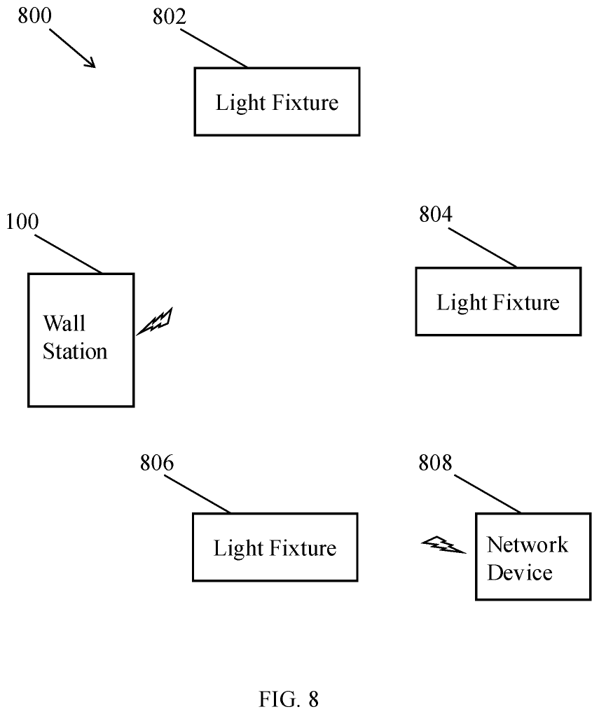

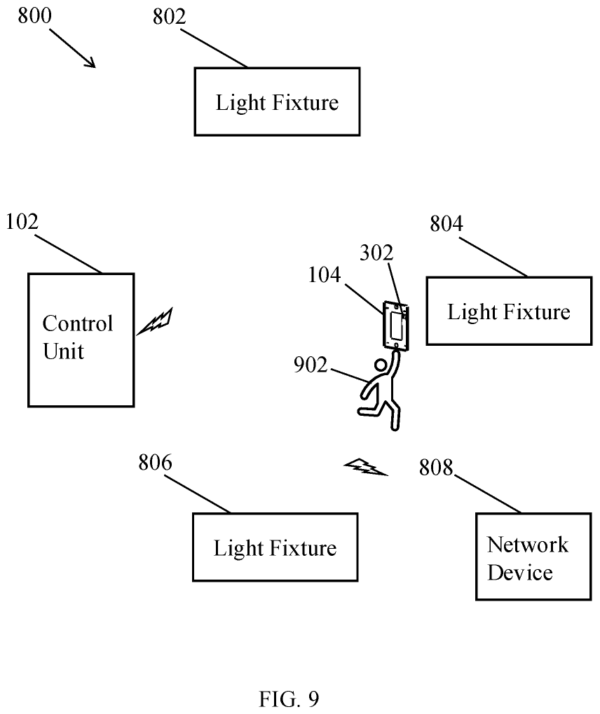

FIG. 8 illustrates a lighting system 800 that includes the wall station 100 of FIG. 1 according to an example embodiment, and FIG. 9 illustrates the lighting system 800 of FIG. 8 with the wall plate 104 of the wall station 100 placed within a threshold distance from a light fixture 804 according to an example embodiment. In some example embodiments, the lighting system 800 includes the wall station 100 and light fixtures 802, 804, 806 that can be paired with the wall station 100 such that the wall station 100 can control the light fixtures 802, 804, 806. For example, each one of the light fixtures 802, 804, 806 may correspond to the light fixture 700 of FIG. 7. The lighting system 800 may also include a network device 808 (e.g., a router or a gateway) that can be used for wireless communication between the wall station 100 and the light fixtures 802, 804, 806, for access to and from the internet or another network.

In some example embodiments, the wall plate 104 of the wall station 100 may be used to pair the wall station 100 with the light fixtures in the manner described above with respect to FIGS. 1-5. Referring to FIGS. 1-9, a user 902 (e.g., a technician or a homeowner) may provide a user input to the wall station 100 via the user input interface 106 of the control unit 102 indicating a commissioning mode, and the control unit 102 may enter the commissioning mode and also broadcast a commissioning mode command in response to the user input. In response to the commissioning mode command from the wall station 100, the light fixtures 802, 804, 806 may enter the commissioning mode. After providing the commissioning mode input to the wall station 100, the user 902 may remove the wall plate 104 from the control unit 102 and move the wall plate 104 along with the RFID tag 302 within the threshold distance of the light fixture 804. The light fixture 804 may wirelessly read the wall station identifier of the wall station 100 from the RFID tag 302 when the RFID tag 302 is within the threshold distance from the light fixture 804. For example, the wall station identifier may have been written to the RFID tag 302 during the manufacturing of wall station 100 or, for example, by the RFID unit 710 of the control unit 102 subsequent to manufacturing. The light fixture 804 may provide an indicator signal (e.g., flashing the light provided by the light fixture 804) to indicate that the RFID unit 710 of the light fixture 804 has read the wall station identifier from the RFID tag 302 of the wall plate 104. The light fixture 804 may exit the commissioning mode, for example, after providing the indicator signal, after a time out period (e.g., 5 minutes or 10 minutes), or upon receiving a command from the wall station 100 to exit the commissioning mode.

In some example embodiments, during the commission mode initiated by the wall station 100, the user 902 may place the wall plate 104 within the threshold distance from the light fixtures 802 before reattaching the wall plate 104 to the control unit 102. For example, the RFID unit 710 of light fixture 802 may wirelessly read the wall station identifier of the wall station 100 from the RFID tag 302 in the manner described with respect to the light fixture 804. After placing wall plate 104 with the threshold distance from the light fixture 802 for a minimum time period or after an indicator signal by the light fixture 802, the user 902 may also place the wall plate 104 within the threshold distance from the light fixture 806 before reattaching the wall plate 104 to the control unit 102. For example, the RFID unit 710 of light fixture 806 may wirelessly read the wall station identifier of the wall station 100 from the RFID tag 302 in the manner described with respect to the light fixture 804.

In some example embodiments, the user 902 may reattach the wall plate 104 back to the control unit 102. For example, upon the user 902 provide an input to the wall station 100 to terminate the commissioning mode, the wall station 100 may exit the commissioning mode and may also broadcast a command indicating end of the commissioning mode. After exiting the commissioning mode, the wall station 100 may transmit lighting control messages that include the wall station identifier to control one or more of the light fixtures 802, 804, 806 that has been successfully paired with the wall station 100 by reading the wall station identifier of the wall station 100 from the RFID tag 302.

In some example embodiments, during the commission mode, instead of or in addition reading the wall station identifier from the RFID tag 302, the RFID unit 710 of the light fixture 804 may write the light fixture identifier of the light fixture 804 to the RFID tag 302 while the wall plate 104 along with the RFID tag 302 are within the threshold distance from the light fixture 804. When the wall plate 104 is reattached to the control unit 102 of the wall station 100, the control unit 102 may read the light fixture identifier of the light fixture 804 from the RFID tag 302 attached to the wall plate 104. For example, the RFID unit 610 of the control unit 102 may read the light fixture identifier of the light fixture 804 from the RFID tag 302 wirelessly or via the wired connection over the electrical contacts 402. After exiting the commissioning mode, the wall station 100 may wirelessly transit lighting control messages that include the light fixture identifier of the light fixture 804 to control the light fixture 804 as can be readily understood by those of ordinary skill in the art with the benefit of this disclosure.

In some example embodiments, during the commission mode, the user 902 may move the wall plate 104 within the threshold distance of the light fixtures 802 after the RFID unit 710 of the light fixture 804 has written the light fixture identifier of the light fixture 804 to the RFID tag 302. Instead of or in addition reading the wall station identifier from the RFID tag 302, the RFID unit 710 of the light fixture 802 may write the light fixture identifier of the light fixture 802 to the RFID tag 302 while the wall plate 104 along with the RFID tag 302 are within the threshold distance from the light fixture 802. When the wall plate 104 is reattached to the control unit 102 of the wall station 100, the control unit 102 may read the light fixture identifiers of the light fixture 802 and 804 from the RFID tag 302 attached to the wall plate 104. For example, the RFID unit 610 of the control unit 102 may read the light fixture identifiers of the light fixtures 802 and 804 from the RFID tag 302 wirelessly or via the wired connection over the electrical contacts 402. After exiting the commissioning mode, the wall station 100 may wirelessly transit lighting control messages that include the light fixture identifier of the light fixture 802 to individually control the light fixture 802 as can be readily understood by those of ordinary skill in the art with the benefit of this disclosure. The wall station 100 may also wirelessly transit lighting control messages that include the light fixture identifier of the light fixture 804 to individually control the light fixture 804 as can be readily understood by those of ordinary skill in the art with the benefit of this disclosure. The wall plate 104 may also be used with respect to the light fixture 806 and other light fixtures of the lighting system 800 in the manner described with respect to the light fixtures 802, 804 to obtain the light fixture identifiers and individually control the light fixture 806 and other light fixtures.

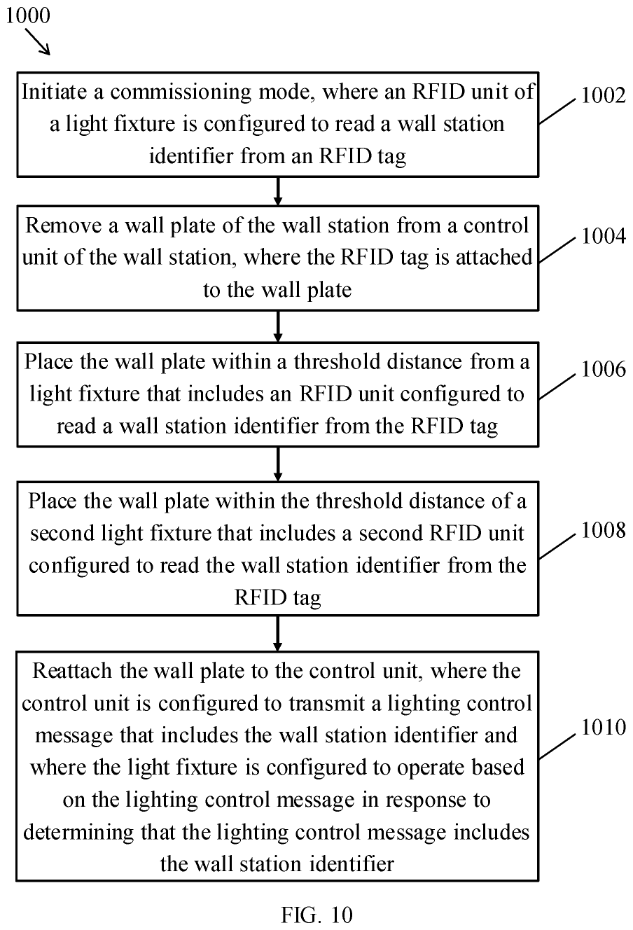

In some example embodiments, the lighting system 800 may include more or fewer light fixtures than shown in FIGS. 9 and 10 without departing from the scope of this disclosure. In some alternative embodiments, the lighting system 800 may include other instances of the wall station 100 without departing from the scope of this disclosure. In some example embodiments, the threshold distance required for light fixtures of the system 800 to read and/or write to the RFID tag 302 attached to the wall plate 104 may be different among one light fixture to another. In some alternative embodiments, the network device 808 may be omitted without departing from the scope of this disclosure. In some alternative embodiments, the lighting system 800 may include other components without departing from the scope of this disclosure.

FIG. 10 illustrates a method 1000 of configuring the lighting system 800 of FIG. 8 according to an example embodiment. Referring to FIGS. 1-10, in some example embodiments, at step 1002, the method 1000 includes initiating a commissioning mode. For example, the user 902 may provide one or more user inputs to the wall station 100 via the user input interface 106, and the RFID unit 710 of the light fixture 804 may be configured to read the wall station identifier of the wall station 100 from the RFID tag 302 during the commissioning mode. At step 1004, the method 1000 may include removing the wall plate 104 of the wall station 100 from the control unit 102 of the wall station 100, where the RFID tag 302 is attached to the wall plate 104.

In some example embodiments, at step 1006, the method 1000 includes placing the wall plate 104 within a threshold distance from the light fixture 804 that includes the RFID unit 710 that is configured to read a wall station identifier of the wall station 100 from the RFID tag 302. At step 1008, the method 1000 may include placing the wall plate 104 within the threshold distance of the light fixture 802 that includes the RFID unit 710 configured to read the wall station identifier from the RFID tag 302. At step 1010, the method 1000 includes reattaching the wall plate 104 to the wall control unit 102 of the wall station 100. The control unit 102 is configured to transmit a lighting control message that includes the wall station identifier of the wall station 100, and the light fixture 804 is configured to operate based on the lighting control message in response to determining that the lighting control message includes the wall station identifier of the wall station 100.

In some alternative embodiments, the method 1000 may include more or fewer steps than shown without departing from the scope of this disclosure. In some alternative embodiments, the steps of the method 1000 may be performed in a different order than shown without departing from the scope of this disclosure.

Although particular embodiments have been described herein in detail, the descriptions are by way of example. The features of the embodiments described herein are representative and, in alternative embodiments, certain features, elements, and/or steps may be added or omitted. Additionally, modifications to aspects of the embodiments described herein may be made by those skilled in the art without departing from the scope of the following claims, the scope of which are to be accorded the broadest interpretation so as to encompass modifications and equivalent structures.

1. A lighting system comprising:
a wall station having a wall plate that is removably attachable to a control unit of the wall station, wherein a radio-frequency identification (RFID) tag is attached to the wall plate; and
a light fixture remotely located from the wall station comprising an RFID unit configured to, during a commissioning mode, read a wall station identifier from the RFID tag when the wall plate with the attached RFID tag is placed within a threshold distance from the light fixture, wherein the wall station identifier associates the light fixture with the wall station or the control unit of the wall station, and
wherein, subsequent to the commissioning mode, the control unit of the wall station is configured to transmit, via a communication interface module, a lighting control message that includes the wall station identifier and wherein the light fixture is configured to operate based on the lighting control message in response to determining that the lighting control message includes the wall station identifier.

2. The lighting system of claim 1, wherein the RFID unit is configured to read the wall station identifier from the RFID tag during the commissioning mode entered in response to a commissioning command received by the light fixture.

3. The lighting system of claim 1, wherein the RFID tag is a near-field communication tag.

4. The lighting system of claim 1, wherein the threshold distance is less than an installation distance between the wall station and the light fixture.

5. The lighting system of claim 1, wherein the RFID unit is configured to write a light fixture identifier of the light fixture to the RFID tag when the RFID tag is within the threshold distance from the light fixture.

6. The lighting system of claim 5, wherein the control unit is configured to read the light fixture identifier of the light fixture from the RFID tag when the RFID tag is attached to the control unit.

7. The lighting system of claim 6, wherein the control unit is configured to read the light fixture identifier of the light fixture from the RFID tag via a wired connection.

8. The lighting system of claim 1, wherein the control unit is configured to write the wall station identifier to the RFID tag.

9. The lighting system of claim 1, wherein the RFID tag is attached to a surface of the wall plate facing the control unit.

10. The lighting system of claim 9, wherein the wall plate is attached to the control unit using one or more snaps.

11. The lighting system of claim 1, further comprising a second light fixture comprising a second RFID unit configured to read the wall station identifier from the RFID tag when the RFID tag is within the threshold distance from the second light fixture, wherein the second light fixture is configured to operate based on the lighting control message in response to determining that the lighting control message includes the wall station identifier.

12. A method of configuring a lighting system, the method comprising:
removing a wall plate of a wall station from a control unit of the wall station, wherein a radio-frequency identification (RFID) tag is attached to the wall plate;
placing the wall plate along with the RFID tag within a threshold distance from a light fixture that comprises an RFID unit and while the light fixture is in a commissioning mode, the RFID unit reads a wall station identifier from the RFID tag, wherein the wall station identifier associates the light fixture with the wall station or the control unit of the wall station; and
subsequent to the RFID unit reading the wall station identified from the RFID tag, attaching the wall plate to the control unit wherein, subsequent to the commissioning mode, the control unit is configured to transmit, via a communication interface module, a lighting control message that includes the wall station identifier and wherein the light fixture is configured to operate based on the lighting control message in response to determining that the lighting control message includes the wall station identifier.

13. The method of claim 12, further comprising placing the wall plate within the threshold distance of a second light fixture that comprises a second RFID unit configured to read the wall station identifier from the RFID tag.

14. The method of claim 12, wherein the RFID unit is configured to write a light fixture identifier of the light fixture to the RFID tag when the RFID tag is within the threshold distance from the light fixture and wherein the control unit is configured to read the light fixture identifier of the light fixture from the RFID tag when the wall plate is attached to the control unit.
